(19) United States
(12) Patent Application Publication
(10) Pub. No.: US 2024/0187191 A1
(43) Pub. Date: Jun. 6, 2024

(54) ENHANCED PREAMBLE FOR 60 GIGAHERTZ OPERATION

(71) Applicant: Intel Corporation, Santa Clara, CA (US)

(72) Inventors: Thomas J. KENNEY, Portland, OR (US); Shahrnaz AZIZI, Cupertino, CA (US); Laurent CARIOU, Milizac (FR); Juan FANG, Portland, OR (US)

(73) Assignee: Intel Corporation, Santa Clara, CA (US)

(21) Appl. No.: 18/401,102

(22) Filed: Dec. 29, 2023

(51) Int. Cl. H04L 5/00

(52) U.S. Cl. CPC H04L 5/0053

(57) ABSTRACT

This disclosure describes systems, methods, and devices related to enhanced 60 gigahertz (GHz) preamble. A device may generate a frame for 60 GHz transmission, the frame comprising one or more fields to carry information associated with one or more station devices (STAs). The device may generate a modified legacy signal (L-SIG) field comprising one or more subfields for operation in the 60 GHz transmission. The device may generate a modified legacy long training field (L-LTF) for operation in the 60 GHz transmission. The device may utilize 56 subcarriers in the modified L-LTF in the frame. The device may cause to send the frame comprising the modified L-LTF and the modified L-SIG to the one or more STAs.

### TECHNICAL FIELD

This disclosure generally relates to systems and methods for wireless communications and, more particularly, to enhanced preamble for 60 gigahertz (GHz) operation.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for enhanced 60 GHz preamble, in accordance with one or more example embodiments of the present disclosure.

FIGS. 2-6, 7A-7C depict illustrative schematic diagrams for enhanced 60 GHz preamble, in accordance with one or more example embodiments of the present disclosure.

FIG. 8 illustrates a flow diagram of a process for an illustrative enhanced 60 GHz preamble system, in accordance with one or more example embodiments of the present disclosure.

FIG. 9 illustrates a functional diagram of an exemplary communication station that may be suitable for use as a user device, in accordance with one or more example embodiments of the present disclosure.

FIG. 10 illustrates a block diagram of an example machine upon which any of one or more techniques (e.g., methods) may be performed, in accordance with one or more example embodiments of the present disclosure.

FIG. 11 is a block diagram of a radio architecture in accordance with some examples.

FIG. 12 illustrates an example front-end module circuitry for use in the radio architecture of FIG. 11, in accordance with one or more example embodiments of the present disclosure.

FIG. 13 illustrates an example radio IC circuitry for use in the radio architecture of FIG. 11, in accordance with one or more example embodiments of the present disclosure.

FIG. 14 illustrates an example baseband processing circuitry for use in the radio architecture of FIG. 11, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

For Wi-Fi 8, a notable advancement is incorporating operations at 60 GHz, a high-frequency range, into mainstream Wi-Fi, marking a shift in Wi-Fi technology. This eighth-generation Wi-Fi aims to offer faster speeds and more robust connections. Key to this development is the formation of a Task Group, tasked with developing Wi-Fi standards, set to commence work 6 months post the initiation of Wi-Fi 8 development for lower frequency bands (2.4 GHz and 5 GHz). This integration into the mainstream is now more feasible due to several factors. Firstly, cost reduction through innovative device architecture enables the use of the same baseband—the component processing signals—for both traditional lower band Wi-Fi and 60 GHz radio. This approach minimizes costs and simplifies design. Secondly, the potential for enhancing throughput, the volume of data transmitted over a network in a given time, is nearing its peak in lower bands, leading to a pivot towards higher frequencies like 60 GHz for improved performance. Finally, the introduction of a multi-link framework simplifies the management of multiple wireless connections. This system is vital in balancing the inherently fragile 60 GHz connections, which are more susceptible to obstructions than lower frequency signals, by providing a reliable fallback to lower band operations, ensuring continuous connectivity. These innovations in Wi-Fi 8 represent a significant step forward in wireless technology, offering more efficient and reliable internet access.

The process of defining main Physical Layer (PHY) characteristics for 60 GHz operation in Wi-Fi technology is underway, focusing on minimizing changes to the baseband design. The baseband, a key component in wireless communications, processes the digital signals. This effort aims to maximize the reuse of elements from the existing Wi-Fi systems, which operate at lower frequency bands (2.4 GHz and 5 GHz). However, adapting to the higher 60 GHz band necessitates certain exceptions.

One such adaptation involves employing different upclocking rates. Upclocking is a technique used to increase the frequency of a clock signal within a circuit, affecting the rate at which data is processed. Another adjustment is modifying the subcarrier spacing, a technique in signal modulation where data is distributed across various frequencies within a channel. This helps optimize bandwidth usage and minimizes interference. At the 60 GHz frequency, increasing subcarrier spacing is particularly important to counteract phase noise, a type of disturbance more prevalent at higher frequencies. Phase noise refers to the frequency stability in a signal, and managing it is crucial for maintaining the quality and reliability of wireless communication at these higher frequencies.

These changes are essential to ensure that Wi-Fi operation at 60 GHz not only becomes viable but also maintains the high standards of efficiency and reliability expected in modern wireless networks. The development underscores the complexities and technical innovations required to extend Wi-Fi technology into new, higher frequency bands.

The central goal in developing a 60 GHz PHY for Wi-Fi is to maximize the reuse of existing lower band Wi-Fi PHY designs. A straightforward method proposed to achieve this is the upclocking technique. Upclocking involves increasing the frequency of the PHY's clock signal by a specific factor. In this case, the suggestion is to upclock by a factor of 8. For example, a 20 MHz Physical Protocol Data Unit (PPDU)— like that used in the 802.11ac standard—would be transformed into a 160 MHz PPDU for operation at 60 GHz.

This method leads to the definition of 160 MHz, 320 MHz, and 640 MHz channel bandwidths at 60 GHz. These bandwidths represent the frequency range over which the Wi-Fi signal is transmitted, and larger bandwidths can allow for higher data rates. However, while this upclocking approach is straightforward, it presents a notable challenge: the channel selections it proposes do not align with the current 60 GHz channels used in Wi-Fi standards like 802.11ad and 802.11 ay. These standards use 2.16 GHz channels, which are significantly wider than those proposed through the upclocking method.

The discrepancy in channel bandwidths highlights a key consideration in the development of the 60 GHz PHY: balancing the desire for compatibility and reuse of existing lower band technologies with the need to accommodate the unique characteristics and requirements of the 60 GHz frequency band. This situation illustrates the complexities involved in extending Wi-Fi technology into higher frequency bands while trying to maintain compatibility with established standards and practices.

While maximum reuse is the target for the system in 60 GHz band, this also provides the chance to fix some issues with the lower band system that were created due to legacy definitions in the original Wi-Fi OFDM system (802.11g/a).

A method to change the contents and use the L-SIG is proposed. Basically, repurpose the L-SIG bit definitions (and in some cases structure) to improve system performance since legacy systems will not be present in the new band. Further, an approach is to define a new L-LTF and L-SIG to optimize use in the new band.

The proposed approach, while reusing existing lower band Wi-Fi PHY technology, necessitates a modification to the preamble of the signal. The preamble in a wireless communication signal is a sequence of bits used for synchronization and other purposes, and it's a critical component of the PHY layer. Altering the preamble for 60 GHz operation is considered a relatively minor change from a hardware perspective, as it focuses on maximizing the reuse of current hardware. This approach is advantageous because it limits the need for extensive redesigns or the introduction of entirely new hardware components, thereby reducing development costs and complexity.

In addition to these changes, there is also consideration for refining beam steering capabilities as part of the 60 GHz Wi-Fi development. Beam steering is a technique used in wireless communications to direct the signal beam towards a specific receiving device, improving signal strength and reliability, particularly in environments with obstacles or interference. This technique is even more crucial at higher frequencies like 60 GHz, where signals have shorter wavelengths and are more prone to attenuation and blockage. Refining beam steering would involve improving the way the signal is directed and managed, ensuring more efficient and reliable communication.

While an objective is to adapt the existing lower band Wi-Fi PHY for 60 GHz use with minimal changes, the specific requirements of the 60 GHz band, like the need for an altered preamble and enhanced beam steering, necessitate focused modifications. These adaptations are essential to ensure that the high-frequency operation not only is feasible but also maintains the high performance and reliability standards set by current Wi-Fi technology.

Example embodiments of the present disclosure relate to systems, methods, and devices for Wi-Fi 8 60 GHz operation with modified preamble.

In one embodiment, an enhanced 60 GHz preamble system may facilitate a few new L-SIG structures for enhancements to the lower band Wi-Fi 8 system for operation in the 60 GHz band. Although the overall design of the new 60 GHz system is to reuse the blocks from the lower system, it seems advantageous to make minor changes that will greatly improve system performance and utilization. In one embodiment, an enhanced 60 GHz preamble system may redefine the L-LTF and L-SIG while keeping the L-STF untouched. The enhanced 60 GHz preamble system may allow the L-LTF to sound 56 subcarriers instead of the 52 subcarriers as done in previous generations. Thus, the L-SIG would have 52 data subcarriers and 4 pilot subcarriers as opposed to the 48 data and 4 pilot currently. This provides at least two advantages, first it allows the preamble to utilize 56 tones (data+pilot) throughout the signaling as opposed to a stepped approach done in previous legacy systems, where the L-SIG had 52 total subcarriers and the HE/EHT SIG fields had 56 total. This required extra sounding to be inserted in the L-SIG. The second advantage is the extra data tones that will be available in the first SIG field. Further, there is an option to refine beam steering using the L-STF/LTF/SIG.

To accommodate additional subcarriers in the L-LTF of a WiFi frame, significant modifications are made to its structure. Firstly, the extra subcarriers are allocated within the channel's frequency spectrum. The preamble, which comprises the L-LTF, is extended or altered to embed these new frequency components, effectively changing the duration and composition of the L-LTF. This involves adjusting the known signal patterns (training symbols) within the L-LTF, ensuring each new subcarrier transmits the correct portion of the sequence. The receiver's channel estimation algorithms also become more complex, requiring enhancements to accurately process the information from the expanded L-LTF. Care is taken to prevent overlap or interference with adjacent channels by fine-tuning guard intervals and subcarrier spacing. These modifications in the L-LTF can influence the entire frame structure, affecting the frame's duration and the allocation of data and control fields, thus requiring a comprehensive approach to maintain system efficiency and integrity.

The above descriptions are for the purpose of illustration and are not meant to be limiting. Numerous other examples, configurations, processes, algorithms, etc., may exist, some of which are described in greater detail below. Example embodiments will now be described with reference to the accompanying figures.

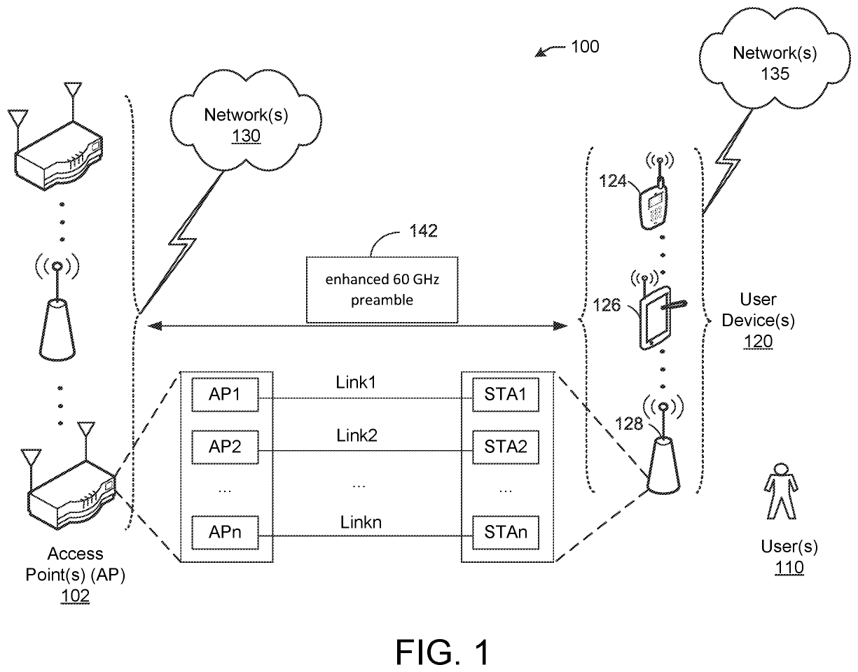

FIG. 1 is a network diagram illustrating an example network environment of enhanced 60 GHz preamble, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

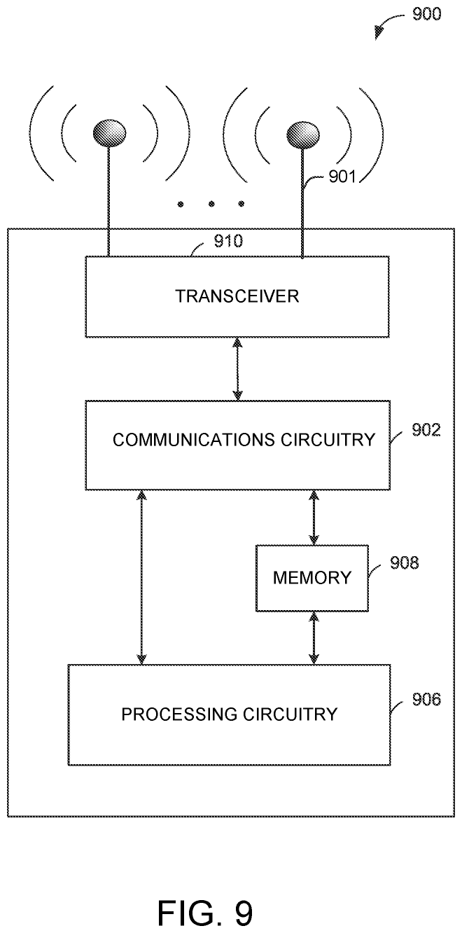

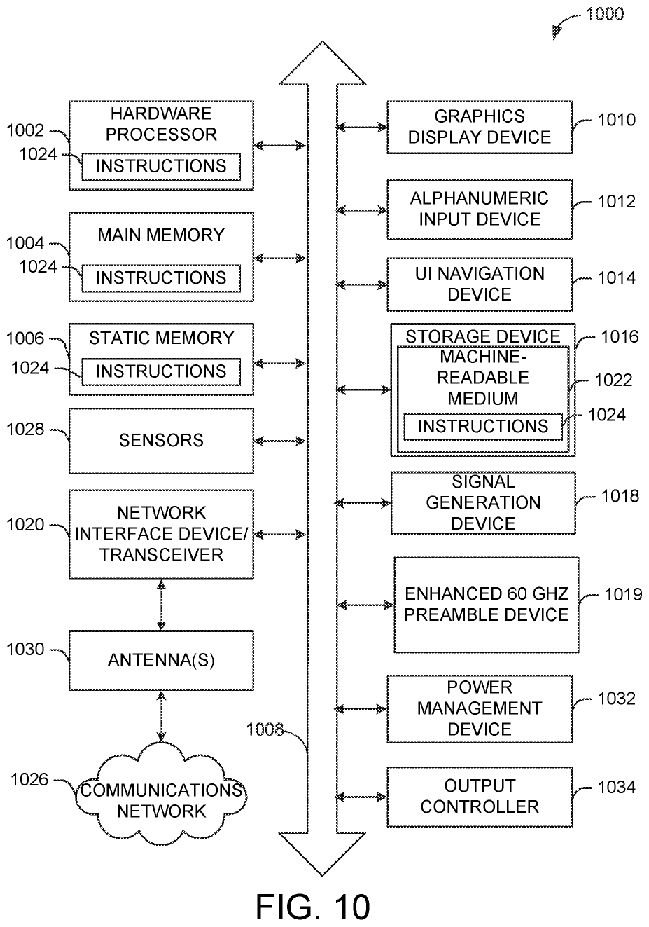

In some embodiments, the user devices 120 and the AP 102 may include one or more computer systems similar to that of the functional diagram of FIG. 9 and/or the example machine/system of FIG. 10.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an enhanced 60 GHz preamble 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, APn, where n is an integer) and each of the one or more user devices 120 may comprise a plurality of individual STAs (e.g., STA1, STA2, STAn). The AP MLDs and the non-AP MLDs may set up one or more links (e.g., Link1, Link2, Linkn) between each of the individual APs and STAs. It is understood that the above descriptions are for the purposes of illustration and are not meant to be limiting.

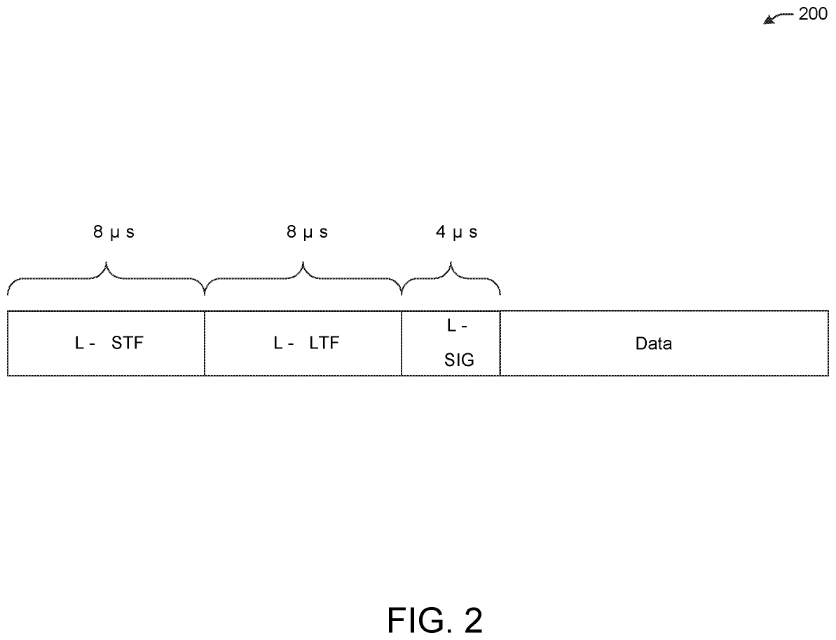

FIGS. 2-6, 7A-7C depict illustrative schematic diagrams for enhanced 60 GHz preamble, in accordance with one or more example embodiments of the present disclosure.

In one or more embodiments, an enhanced 60 GHz preamble system may facilitate a mechanism to provide enhancements to the lower band Wi-Fi 8 system for operation in the 60 GHz band. In the original OFDM Wi-Fi system (802.11a/g), the PPDU consisted of a preamble, made up of the Short Training field (STF), a Long Training Field (LTF), a Signal Field (SIG), and then the data payload. In later versions of the standards this preamble was renamed as the Legacy Preamble, thereafter, named the L-STF, L-LTF and L-SIG respectively. In all versions after the Legacy system, the legacy preamble was used as the beginning of all PPDUs to afford backward compatibility to the legacy system. Although the overall design of the new 60 GHz system is to reuse the blocks from the lower system, it seems advantageous to make changes that will greatly improve system performance and utilization.

In one or more embodiments, an enhanced 60 GHz preamble system may redefine the L-LTF and L-SIG while keeping the L-STF untouched. The enhanced 60 GHz preamble system may allow the L-LTF to sound 56 subcarriers instead of the 52 subcarriers as done in previous generations. Thus, the L-SIG would have 52 data subcarriers and 4 pilot subcarriers as opposed to the 48 data and 4 pilot currently. This provides at least two main advantages, first it allows the preamble to utilize 56 tones (data+pilot) throughout the signaling as opposed to a stepped approach done in previous legacy systems, where the L-SIG had 52 total subcarriers and the HE/EHT SIG fields had 56 total. This required extra sounding to be inserted in the L-SIG. The second advantage is the extra data tones that will be available in the first SIG field. Further, there is an option to refine beam steering using the L-STF/LTF/SIG.

In WiFi communication, “sounding” subcarriers is a technique used to evaluate and understand the characteristics of the wireless channel. Sounding, provides known data sequences for the receiver to use in order to estimate the channel and compute channel estimates used to coherently demodulate the data portion of the payload. This process involves the transmission of known signals across a specified number of subcarriers. Through this method, the system gains insights into channel conditions, including factors like signal attenuation, delay, and the impact of environmental variables. This information is important for optimizing data transmission, ensuring the signals are adapted to current environmental conditions and obstacles. Additionally, sounding facilitates the calibration of signals between the transmitter and receiver, enhancing alignment and reducing transmission errors. Adding extra tones in the LTF sounding allows extra data symbols to be transmitted for the L-SIG then could be transmitted in previous Wi-Fi generations.

In the legacy system, original OFDM Wi-Fi (e.g., 802.11a/g/n, etc.), the preamble was designed with specific design constraints. While it would be useful to redesign the entire PPDU to minimize the length and potentially improve performance, doing so would then result with two different PHY designs between the lower band and 60 GHz operation. Since it was decided that the main goal is to reuse the lower band design as much as possible, such large changes would violate this main goal.

The approach also has the assumption that the synchronization on a beam refinement perspective was done using a separate packet exchange. This would likely be done using a procedure similar to that done in 802.11ad, but using the lower band for the feedback from the STA. As part of the 60 GHz requirements, it is going to mandated that to use a 60 GHz channel, the AP and STA will have a connection on the lower band, where all the link setups will be conducted, and that this band will aid in the beam selection and refinement for the 60 GHz Tx/Rx antennas. Thus, the packets discussed herein are separate from the process, and the two links have sufficient link/antenna alignment to close a link using the lower band packet structure.

Referring to FIG. 2, there is shown a structure 200 of the legacy Wi-Fi system PPDU.

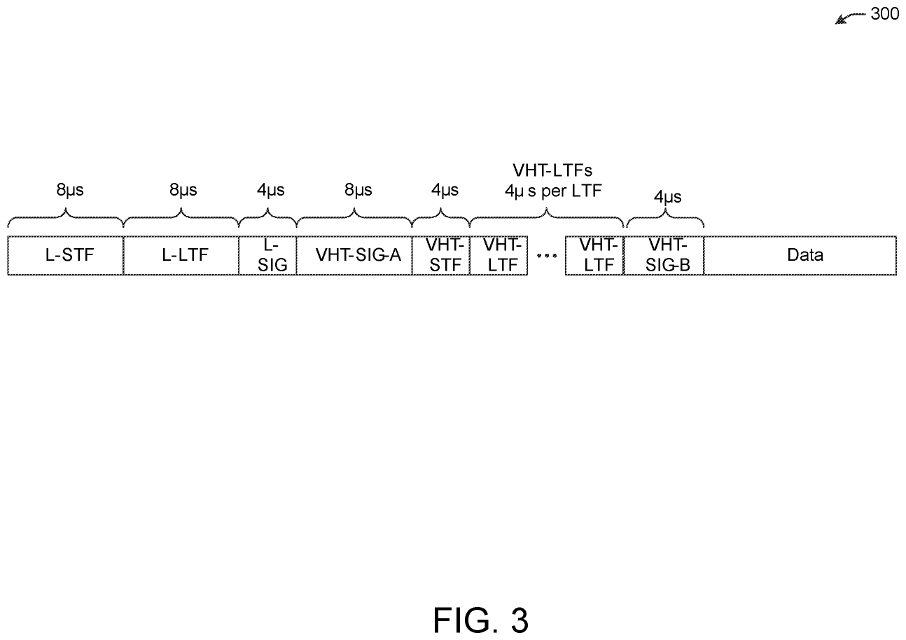

The issue that has occurred in follow-on versions to the legacy system was the necessity to always reuse this Legacy preamble at the beginning of each new PPDU defined (with the exception of greenfield (GF) mode in 802.11n). In each of those systems this was followed by additional preamble symbols for further training and signaling. This can be seen in FIG. 3.

Referring to FIG. 3, there is shown a PPDU structure 300 for the 802.11ac system showing the Legacy portion unchanged from the original system.

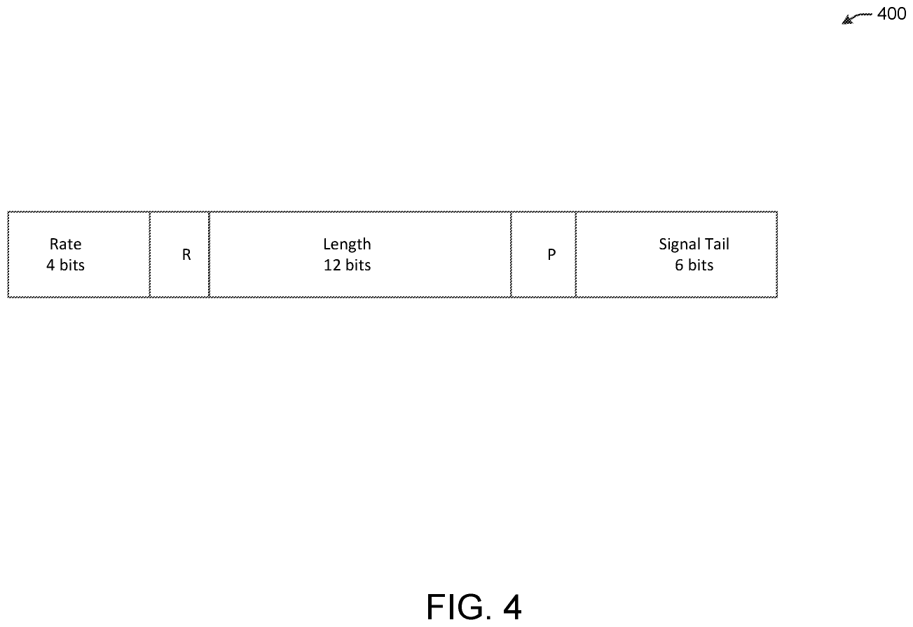

The issue is that the legacy SIG, while sufficient in the original system, does create some limitations for system operation. To outline these deficiencies the content of the L-SIG is shown in FIG. 4.

Referring to FIG. 4, there is shown Contents 400 of the L-SIG.

The L-SIG consists of 24 bits which is encoded with a rate 1/2 Convolutional encoder, interleaved and mapped to 48 data subcarriers, along with the mapping of 4 pilot subcarriers and then the other subcarriers, of the 64 total, are nulled and used as guard and one null at DC. This is then modulated using binary phase shift keying (BPSK) modulation. Of the 24 bits, there is the Rate field with consists of 4 bits and has a mapping as outlined in Table 1, a single reserved bit (R), a 12-bit Length field which indicates the number of Octets in the PSDU, a parity bit (P), and then a 6-bit signal tail.

TABLE 1
Description of the Rate Field in the L-SIG.

| | Rate (Mb/s) 20 MHz |
|---|---|
| Rate bit 1 to 4 | channel spacing |
| 1101 | 6 |
| 1111 | 9 |
| 0101 | 12 |
| 0111 | 18 |
| 1001 | 24 |
| 1011 | 36 |
| 0001 | 48 |
| 0011 | 54 |

The L-SIG field plays a crucial role in Wi-Fi communication, particularly in relation to the Data portion of the PPDU. The L-SIG is part of the preamble in Wi-Fi frames and serves two main purposes. First, it conveys essential information for decoding the Data field, such as the modulation and coding scheme (MCS) used. The MCS determines how data is formatted and modulated for transmission, and understanding this is key for a receiver to correctly interpret the incoming data. Secondly, the L-SIG indicates the length of the Data field in octets (an octet is a unit of digital information that consists of eight bits). This information is vital for devices in a Wi-Fi network to understand how long the Data field is and to process it correctly.

Moreover, and perhaps more significantly across all versions of Wi-Fi standards, these L-SIG values play a role in clear channel assessment (CCA). CCA is a process by which Wi-Fi devices determine whether a channel is clear and available for transmission or if it is occupied. The L-SIG aids in this by signaling the length of the PPDU. This information is used to set the Network Allocation Vector (NAV) across all devices in the network. The NAV is a timer that helps devices avoid collisions by indicating how long the medium (air in case of Wi-Fi) will be busy. By knowing the PPDU length through the L-SIG, devices can set their NAV timers, accordingly, ensuring coordinated and collision-free data transmission in the network.

In essence, the L-SIG is a fundamental component in Wi-Fi communication protocols, contributing to both the accurate decoding of data and the efficient management of network resources to maintain smooth and uninterrupted wireless communication.

There are several issues that need to be worked around with having the L-SIG as the first signaling in all future releases of the standard. The first was lack of protection. The L-SIG design protection consists of only a single parity bit. This creates issues since, as mentioned above, the L-SIG is used by all devices to set the NAV and to abort decoding of any packet. Some extra protection can be afforded if it is assumed the Reserved bit is always the same in all releases (which currently is the case). Then that can be used as a fixed value check. Additionally, since the Rate field only uses 9 values of the 4 bits, a check can be made for a valid rate field. These provide some extra protection but are still very limited. Furthermore, since the Rate field is based on rates used in the original OFDM Wi-Fi system, the limited number of rates afforded in the signaling renders that field useless in future versions where there are numerous Resource Unit (RU) sizes, multiple bandwidths in addition to multiple streams, there are now hundreds of data rates possible. In fact, starting in release 802.11n and continuing for all future rates, only one rate was used in the L-SIG, the lowest rate of 6 Mb/s. This was done to provide the longest possible NAV setting.

Since the 60 GHz system will likely be based initially on either 802.11ac or 802.11ax, the PPDU structures, which would include the L-SIG, are expected to be adapted accordingly to suit the higher frequency band while maintaining core elements of these existing standards. Furthermore, since the 60 GHz band will have no legacy Wi-Fi systems, it seems prudent to make changes small changes to the Legacy preamble to improve overall system performance.

In one or more embodiments, an enhanced 60 GHz preamble system may facilitate keeping a similar PPDU structure as in the lower band system, but just create a modified L-LTF and L-SIG. There is also an option of repeating the L-STF/L-LTF and L-SIG for range extension or aid in preamble detection. These changes are done in a way to minimize impact to implementation design while providing a significant system performance improvement.

In one or more embodiments, an enhanced 60 GHz preamble system may facilitate that based on the 802.11ac system in FIG. 3, modifying the L-LTF and the L-SIG. As outlined above, the L-SIG utilizes 52 subcarriers (48 for data and 4 for pilot). In the systems following the legacy system (802.11n, 802.11ac, 802.11be, etc.), use 56 tones for the 20 MHz channels (52 for data and 4 for pilot). Thus, the legacy portion has 4 subcarriers that are not used when compared to the follow-on standards. Thus, an enhanced 60 GHz preamble system may modify the L-LTF to incorporate 4 additional subcarriers and that the L-SIG would have 4 additional subcarriers for data.

In the context of the L-LTF within a WiFi system using OFDM, the assignment of values to subcarriers, as represented by an example sequence {1, 1, −1, −1, . . . }, plays a critical role in the modulation and transmission of data. These values, 1 and −1, indicate binary phase shift keying (BPSK) modulation, where each number corresponds to a specific phase used to modulate a subcarrier-typically, ‘1’ represents a phase of 0 degrees and ‘−1’ a phase of 180 degrees. This method of modulation is especially effective in high-frequency environments like the 60 GHz band, where signal integrity can be a challenge. The specific pattern of these phase shifts is used to encode information, with the receiver using this known pattern for channel estimation and synchronization, comparing the expected signal with the received one to deduce channel characteristics.

In one or more embodiments, an enhanced 60 GHz preamble system may use the L-LTF, with the addition of sounding 2 subcarriers on each of the band. The original subcarriers will use the same assignments as was done in the legacy system for ease of implementation. These assignments are for subcarriers −26 to 26:

{1, 1, −1, −1, 1, 1, −1, 1, −1, 1, 1, 1, 1, 1, 1, −1, −1, 1, 1, −1, 1, −1, 1, 1, 1, 1, 0,

1, −1, −1, 1, 1, −1, 1, −1, 1, −1, −1, −1, −1, −1, 1, 1, −1, −1, 1, −1, 1, −1, 1, 1, 1, 1}

In one or more embodiments, the additional 4 subcarriers will have the assignment of [−1−1 −1 1] for subcarriers [−28-27 27 28] respectively. This results in a final subcarrier assignment for the LTF for subcarriers −28 to 28 are:

{−1, −1, 1, 1, −1, −1, 1, 1, −1, 1, −1, 1, 1, 1, 1, 1, 1, −1, −1, 1, 1, −1, 1, −1, 1, 1, 1, 1, 0,

1, −1, −1, 1, 1, −1, 1, −1, 1, −1, −1, −1, −1, −1, 1, 1, −1, −1, 1, −1, 1, −1, 1, 1, 1, 1−1, 1}

This then allows a total of 56 subcarriers to be utilized in the L-SIG (52 with data and 4 with pilot).

Next the signal field would incorporate the extra bits as signaling (providing 2 data bits with BPSK modulation and rate 1/2 convolutional coding).

In one or more embodiments, an enhanced 60 GHz preamble system may incorporate several methods to configure the L-SIG within the 60 GHz assumption but also expand by adding 2 bits. Here the Rate, reserved and parity bit are replaced. The Length field is replaced with a TxTime field, with details for selecting 12 bits outlined below. The Rate field is replaced with a 3-bit Version field and then a 3 bit parity field replaces the previous single bit. Finally, the Signal Tail remains the same at 6 bits. The version field may indicate information that assists a receiving device to determine which version of the standard is used. Although a version field is used, it should be understood that any other field may be used in this location. For example, standard version, a bandwidth field, or a variable field associated with early signaling. The TxTime may be selected as 12 bits to provide the same network allocation vector (NAV) setting afforded in all current Wi-Fi system. Since, starting with 802.11n and continuing for all future releases, the Rate field may be set to one value, the Length field may be a method to signal NAV setting. This would then keep that same process as in those versions, minimizing any hardware/software changes. The version field concept was added in 802.11be in the U-SIG, but as a first design here, this is moved into the L-SIG to simplify hardware implementation by allowing the contents of the remainder of the packet to be know early so the hardware can be configured for demodulation earlier. For example, this can lead to faster transmission speeds and improved performance in wireless communication systems. The Parity field set to 3-bits, while not as strong as protection in other SIG fields, does provide a significant improvement over what is afforded today.

As an additional embodiment, the TxTime could be made shorter to limit the range of setting the NAV and any extra bits could be added to the Parity. Additionally, the VER could use only 2 bits, again providing extra bits to the Parity field. When a device receives a frame that it cannot decode, it needs to wait for a certain period of time. This waiting period is referred to here as TxTime. The waiting period may be equal to the time it takes to transmit the frame, or it may include additional time to account for the reception of a block acknowledgment.

Further, the VER field could be replaced with another field that is deemed more useful to be in the L-SIG for early signaling (such as Bandwidth), or the VER could be completely removed providing all those bits as a split between the TxTime and the Parity. Possible options are below in Table 2, this list is not exhaustive but shows various embodiments.

TABLE 2
Various configurations for the first embodiment for L-SIG payload.

| VER | | | | |
|---|---|---|---|---|
| (or other Field) | TxTime | Parity | Signal Tail | Total |
| # of bits | # of bits | # of bits | # of bits | # of bits |
| 3 | 12 | 3 | 6 | 24 |
| 2 | 12 | 4 | 6 | 24 |
| 3 | 11 | 4 | 6 | 24 |
| 0 | 12 | 6 | 6 | 24 |
| 4 | 11 | 3 | 6 | 24 |

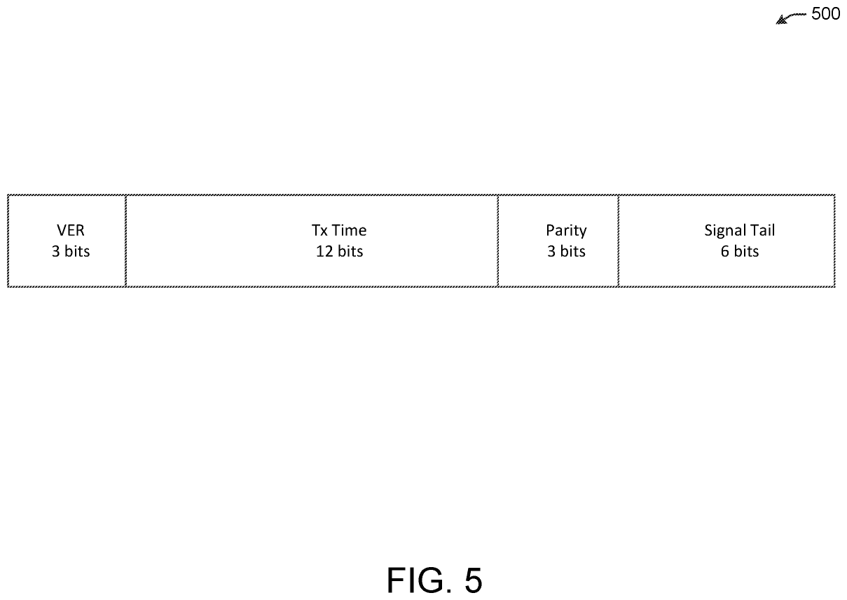

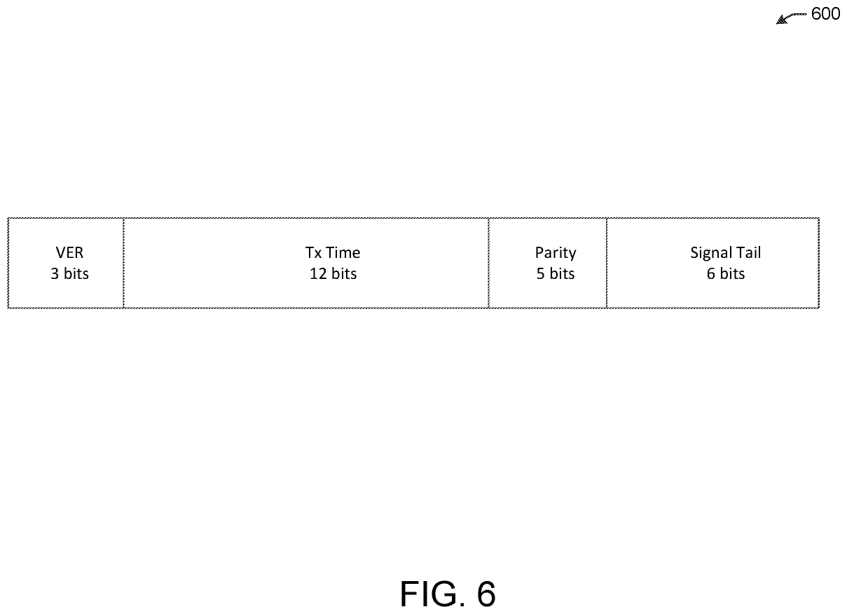

Referring to FIG. 5, there is shown bit allocation 500 of an L-SIG with 1 symbol. Referring to FIG. 6, there is shown another bit allocation 600 of L-SIG with 1 symbol.

FIGS. 5 and 6 provide examples of bit allocation within the 24-bit Legacy Signal (L-SIG) field in a preamble of a frame, each illustrating a unique configuration. FIG. 5, labeled as bit allocation 500, and FIG. 6, designated as bit allocation 600, demonstrate different ways of distributing the 24 bits among the various components of the L-SIG field, such as version information, transmission time (TxTime), parity bits, and the signal tail.

These two figures, while specific in their illustrations, are part of a broader context of bit allocation strategies, as detailed in Table 2 of the same documentation. Table 2 expanded on this concept by presenting a range of examples that showcase the versatility in allocating the 24 bits within the L-SIG field. This table is likely to include various configurations, each tailored to optimize different aspects of wireless communication, such as signal integrity, device compatibility, and network performance.

The combination of FIGS. 5 and 6, along with the comprehensive examples in Table 2, underscores the adaptable and dynamic nature of bit allocation in WiFi technology. While FIGS. 5 and 6 offer concrete instances, Table 2 broadens the perspective, highlighting the structured yet flexible approach to designing the L-SIG field. This adaptability is crucial for meeting diverse technological requirements and operational conditions, showcasing the innovative and evolving character of bit allocation strategies in modern WiFi systems. The array of methodologies within the 24-bit framework of the L-SIG field, as illustrated across these figures and table, reflects the rich spectrum of design possibilities in WiFi communications.

Additionally, the allocation of 5 bits for parity could be lowered to 4 bits with the extra bit going to a new field. It should be noted that TxTime could also be transmit opportunity (TxOP) time. In the standard, a decision can be made regarding which field to include in the L-SIG: either a length field, representing the total number of bits in the transmitted payload, or the TxOp time, indicating the duration the transmission will be active. TxOp offers greater flexibility within the system. This would be particularly useful if, for some reason, the transmitter needs to signal to other devices that the transmission duration is longer than it is. It is possible to use TxOP since the actual TxTime would likely come from the following Signal Fields such as the VHT-SIG (or the new defined name for that SIG field in the 60 GHz band).

In one or more embodiments, an enhanced 60 GHz preamble system may facilitate that the TxTime could be made shorter to limit the range of setting the NAV and any extra bits could be added to the Parity. Additionally, the VER could use only 2 bits, again providing extra bits to the Parity field.

Finally, the VER field could be replaced with another field that is deemed more useful to be in the L-SIG for early signaling (such as Bandwidth), or the VER could be completely removed providing all those bits as a split between the TxTime and the Parity.

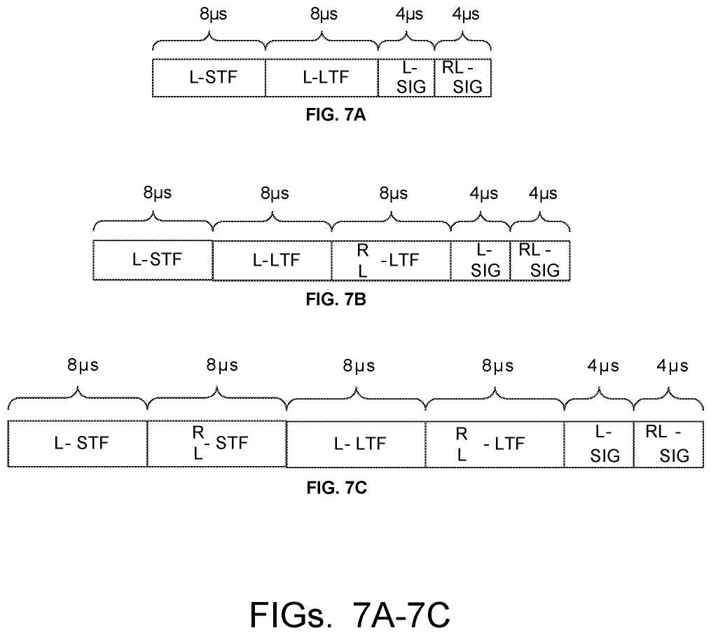

In one or more embodiments, an enhanced 60 GHz preamble system may utilize repeated L-SIG (e.g., FIG. 7A), as was done in the 802.11ax system. This then allows for better detection of the L-SIG.

In one or more embodiments, an enhanced 60 GHz preamble system may repeat both the L-LTF and the L-SIG (e.g., FIG. 7B). This provides better detection of the L-SIG.

In one or more embodiments, an enhanced 60 GHz preamble system may repeat the L-STF, L-LTF and L-SIG (e.g., FIG. 7C).

It is understood that the above descriptions are for the purposes of illustration and are not meant to be limiting.

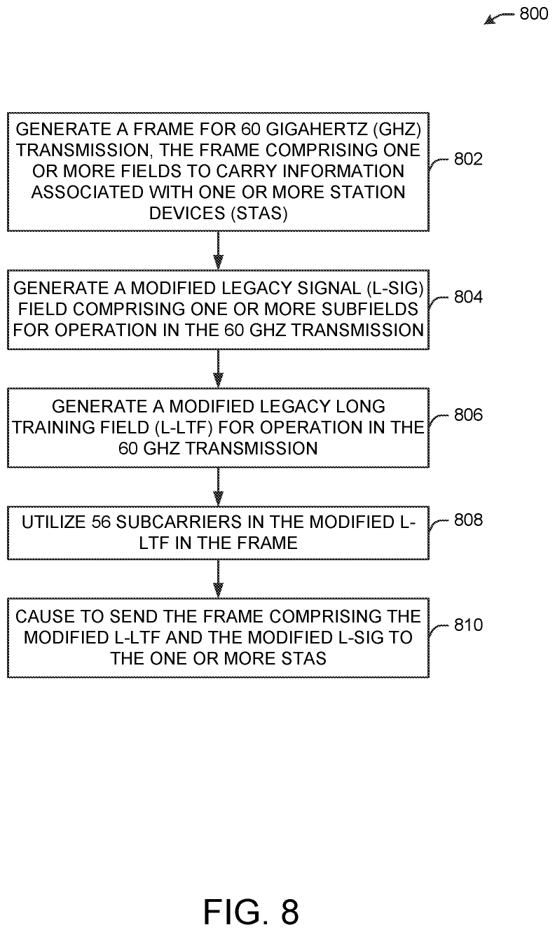

FIG. 8 illustrates a flow diagram of illustrative process 800 for an enhanced 60 GHz preamble system, in accordance with one or more example embodiments of the present disclosure.

At block 802, a device (e.g., the user device(s) 120 and/or the AP 102 of FIG. 1 and/or the enhanced 60 GHz preamble device 1019 of FIG. 10) may generate a frame for 60 gigahertz (GHz) transmission, the frame comprising one or more fields to carry information associated with one or more station devices (STAs).

At block 804, the device may generate a modified legacy signal (L-SIG) field comprising one or more subfields for operation in the 60 GHz transmission.

At block 806, the device may generate a modified legacy long training field (L-LTF) for operation in the 60 GHz transmission.

At block 808, the device may utilize 56 subcarriers in the modified L-LTF in the frame.

At block 810, the device may cause to send the frame comprising the modified L-LTF and the modified L-SIG to the one or more STAs.

In one or more embodiments, the device may include a modified L-SIG field comprising 24 bits distributed among various subfields. These subfields may consist of an early signaling subfield, a transmission time subfield, a parity field subfield, and a signal tail subfield. The early signaling subfield of the device may contain elements like an 802.11 standard version, a bandwidth field, or a variable field associated with early signaling. Additionally, the modified L-SIG of the device may encompass 52 data subcarriers and 4 pilot subcarriers. In the modified L-LTF, the device may feature an additional 4 subcarriers with values of [−1, −1, −1, 1], corresponding to subcarriers [−28, −27, 27, 28]. The transmission time subfield may be a period that signals a legacy device to divert from decoding the frame, while the parity field subfield could be at least 4 bits in length. Furthermore, the modified L-SIG field may be repeated in an adjacent field. Similarly, both the modified L-LTF and the modified L-SIG could be repeated in adjacent fields. The device might also repeat the legacy short training field (L-STF), modified L-LTF, and modified L-SIG in adjacent fields, enhancing its overall functionality.

It is understood that the above descriptions are for the purposes of illustration and are not meant to be limiting.

FIG. 9 shows a functional diagram of an exemplary communication station 900, in accordance with one or more example embodiments of the present disclosure. In one embodiment, FIG. 9 illustrates a functional block diagram of a communication station that may be suitable for use as an AP 102 (FIG. 1) or a user device 120 (FIG. 1) in accordance with some embodiments. The communication station 900 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 900 may include communications circuitry 902 and a transceiver 910 for transmitting and receiving signals to and from other communication stations using one or more antennas 901. The communications circuitry 902 may include circuitry that can operate the physical layer (PHY) communications and/or medium access control (MAC) communications for controlling access to the wireless medium, and/or any other communications layers for transmitting and receiving signals. The communication station 900 may also include processing circuitry 906 and memory 908 arranged to perform the operations described herein. In some embodiments, the communications circuitry 902 and the processing circuitry 906 may be configured to perform operations detailed in the above figures, diagrams, and flows.

In accordance with some embodiments, the communications circuitry 902 may be arranged to contend for a wireless medium and configure frames or packets for communicating over the wireless medium. The communications circuitry 902 may be arranged to transmit and receive signals. The communications circuitry 902 may also include circuitry for modulation/demodulation, upconversion/downconversion, filtering, amplification, etc. In some embodiments, the processing circuitry 906 of the communication station 900 may include one or more processors. In other embodiments, two or more antennas 901 may be coupled to the communications circuitry 902 arranged for sending and receiving signals. The memory 908 may store information for configuring the processing circuitry 906 to perform operations for configuring and transmitting message frames and performing the various operations described herein. The memory 908 may include any type of memory, including non-transitory memory, for storing information in a form readable by a machine (e.g., a computer). For example, the memory 908 may include a computer-readable storage device, read-only memory (ROM), random-access memory (RAM), magnetic disk storage media, optical storage media, flash-memory devices and other storage devices and media.

In some embodiments, the communication station 900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 900 may include one or more antennas 901. The antennas 901 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 900 may include one or more of a keyboard, a display, a non-volatile memory port, multiple antennas, a graphics processor, an application processor, speakers, and other mobile device elements. The display may be an LCD screen including a touch screen.

Although the communication station 900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 900 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 900 may include one or more processors and may be configured with instructions stored on a computer-readable storage device.

FIG. 10 illustrates a block diagram of an example of a machine 1000 or system upon which any one or more of the techniques (e.g., methodologies) discussed herein may be performed. In other embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environments. The machine 1000 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a power management device 1032, a graphics display device 1010, an alphanumeric input device 1012 (e.g., a keyboard), and a user interface (UI) navigation device 1014 (e.g., a mouse). In an example, the graphics display device 1010, alphanumeric input device 1012, and UI navigation device 1014 may be a touch screen display. The machine 1000 may additionally include a storage device (i.e., drive unit) 1016, a signal generation device 1018 (e.g., a speaker), an enhanced 60 GHz preamble device 1019, a network interface device/transceiver 1020 coupled to antenna(s) 1030, and one or more sensors 1028, such as a global positioning system (GPS) sensor, a compass, an accelerometer, or other sensor. The machine 1000 may include an output controller 1034, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1002 for generation and processing of the baseband signals and for controlling operations of the main memory 1004, the storage device 1016, and/or the enhanced 60 GHz preamble device 1019. The baseband processor may be provided on a single radio card, a single chip, or an integrated circuit (IC).

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

The enhanced 60 GHz preamble device 1019 may carry out or perform any of the operations and processes (e.g., process 800) described and shown above.

It is understood that the above are only a subset of what the enhanced 60 GHz preamble device 1019 may be configured to perform and that other functions included throughout this disclosure may also be performed by the enhanced 60 GHz preamble device 1019.

While the machine-readable medium 1022 is illustrated as a single medium, the term “machine-readable medium” may include a single medium or multiple media (e.g., a centralized or distributed database, and/or associated caches and servers) configured to store the one or more instructions 1024.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device/transceiver 1020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (e.g., Ethernet, coaxial, or phone jacks) or one or more antennas to connect to the communications network 1026. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

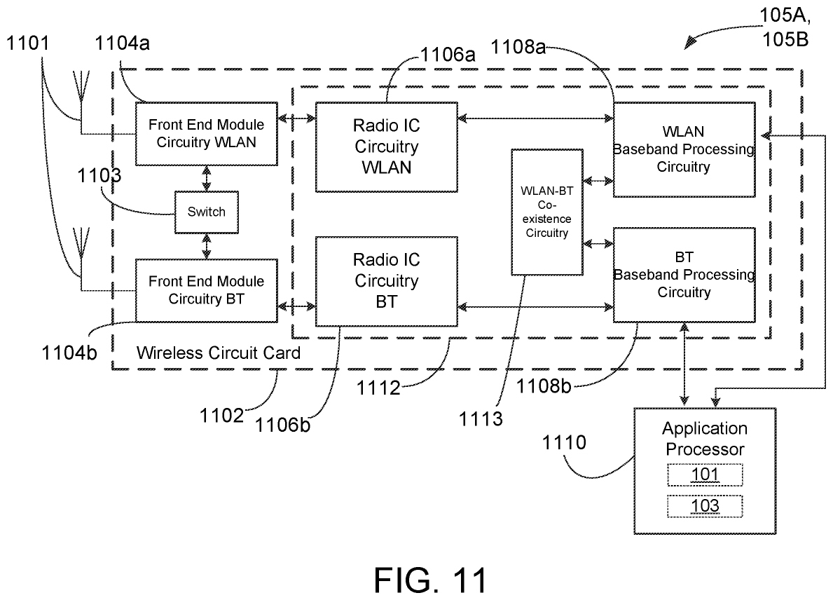

FIG. 11 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1104a-b, radio IC circuitry 1106a-b and baseband processing circuitry 1108a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1104a-b may include a WLAN or Wi-Fi FEM circuitry 1104a and a Bluetooth (BT) FEM circuitry 1104b. The WLAN FEM circuitry 1104a may include a receive signal path comprising circuitry configured to operate on WLAN RF signals received from one or more antennas 1101, to amplify the received signals and to provide the amplified versions of the received signals to the WLAN radio IC circuitry 1106a for further processing. The BT FEM circuitry 1104b may include a receive signal path which may include circuitry configured to operate on BT RF signals received from one or more antennas 1101, to amplify the received signals and to provide the amplified versions of the received signals to the BT radio IC circuitry 1106b for further processing. FEM circuitry 1104a may also include a transmit signal path which may include circuitry configured to amplify WLAN signals provided by the radio IC circuitry 1106a for wireless transmission by one or more of the antennas 1101. In addition, FEM circuitry 1104b may also include a transmit signal path which may include circuitry configured to amplify BT signals provided by the radio IC circuitry 1106b for wireless transmission by the one or more antennas. In the embodiment of FIG. 11, although FEM 1104a and FEM 1104b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1106a-b as shown may include WLAN radio IC circuitry 1106a and BT radio IC circuitry 1106b. The WLAN radio IC circuitry 1106a may include a receive signal path which may include circuitry to down-convert WLAN RF signals received from the FEM circuitry 1104a and provide baseband signals to WLAN baseband processing circuitry 1108a. BT radio IC circuitry 1106b may in turn include a receive signal path which may include circuitry to down-convert BT RF signals received from the FEM circuitry 1104b and provide baseband signals to BT baseband processing circuitry 1108b. WLAN radio IC circuitry 1106a may also include a transmit signal path which may include circuitry to up-convert WLAN baseband signals provided by the WLAN baseband processing circuitry 1108a and provide WLAN RF output signals to the FEM circuitry 1104a for subsequent wireless transmission by the one or more antennas 1101. BT radio IC circuitry 1106b may also include a transmit signal path which may include circuitry to up-convert BT baseband signals provided by the BT baseband processing circuitry 1108b and provide BT RF output signals to the FEM circuitry 1104b for subsequent wireless transmission by the one or more antennas 1101. In the embodiment of FIG. 11, although radio IC circuitries 1106a and 1106b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1108a-b may include a WLAN baseband processing circuitry 1108a and a BT baseband processing circuitry 1108b. The WLAN baseband processing circuitry 1108a may include a memory, such as, for example, a set of RAM arrays in a Fast Fourier Transform or Inverse Fast Fourier Transform block (not shown) of the WLAN baseband processing circuitry 1108a. Each of the WLAN baseband circuitry 1108a and the BT baseband circuitry 1108b may further include one or more processors and control logic to process the signals received from the corresponding WLAN or BT receive signal path of the radio IC circuitry 1106a-b, and to also generate corresponding WLAN or BT baseband signals for the transmit signal path of the radio IC circuitry 1106a-b. Each of the baseband processing circuitries 1108a and 1108b may further include physical layer (PHY) and medium access control layer (MAC) circuitry, and may further interface with a device for generation and processing of the baseband signals and for controlling operations of the radio IC circuitry 1106a-b.

Referring still to FIG. 11, according to the shown embodiment, WLAN-BT coexistence circuitry 1113 may include logic providing an interface between the WLAN baseband circuitry 1108a and the BT baseband circuitry 1108b to enable use cases requiring WLAN and BT coexistence. In addition, a switch 1103 may be provided between the WLAN FEM circuitry 1104a and the BT FEM circuitry 1104b to allow switching between the WLAN and BT radios according to application needs. In addition, although the antennas 1101 are depicted as being respectively connected to the WLAN FEM circuitry 1104a and the BT FEM circuitry 1104b, embodiments include within their scope the sharing of one or more antennas as between the WLAN and BT FEMs, or the provision of more than one antenna connected to each of FEM 1104a or 1104b.

In some embodiments, the front-end module circuitry 1104a-b, the radio IC circuitry 1106a-b, and baseband processing circuitry 1108a-b may be provided on a single radio card, such as wireless radio card 1102. In some other embodiments, the one or more antennas 1101, the FEM circuitry 1104a-b and the radio IC circuitry 1106a-b may be provided on a single radio card. In some other embodiments, the radio IC circuitry 1106a-b and the baseband processing circuitry 1108a-b may be provided on a single chip or integrated circuit (IC), such as IC 1112.

In some embodiments, the wireless radio card 1102 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1108b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., SGPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

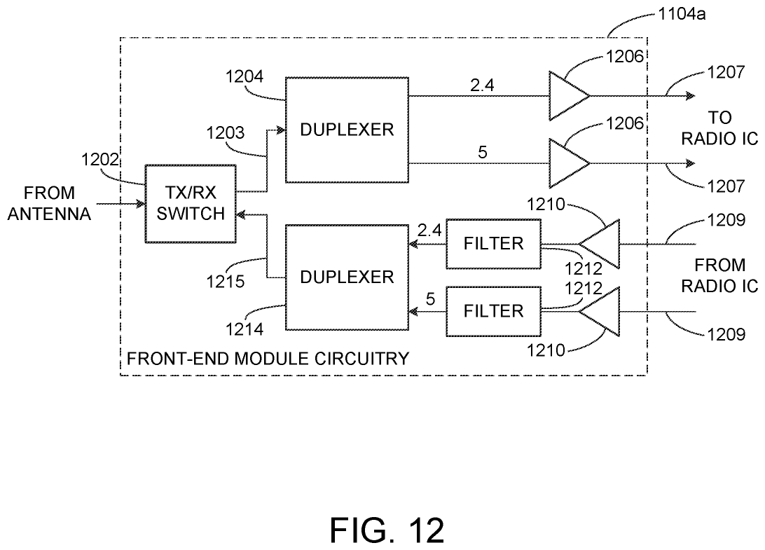

FIG. 12 illustrates WLAN FEM circuitry 1104a in accordance with some embodiments. Although the example of FIG. 12 is described in conjunction with the WLAN FEM circuitry 1104a, the example of FIG. 12 may be described in conjunction with the example BT FEM circuitry 1104b (FIG. 11), although other circuitry configurations may also be suitable.

In some embodiments, the FEM circuitry 1104a may include a TX/RX switch 1202 to switch between transmit mode and receive mode operation. The FEM circuitry 1104a may include a receive signal path and a transmit signal path. The receive signal path of the FEM circuitry 1104a may include a low-noise amplifier (LNA) 1206 to amplify received RF signals 1203 and provide the amplified received RF signals 1207 as an output (e.g., to the radio IC circuitry 1106a-b (FIG. 11)). The transmit signal path of the circuitry 1104a may include a power amplifier (PA) to amplify input RF signals 1209 (e.g., provided by the radio IC circuitry 1106a-b), and one or more filters 1212, such as band-pass filters (BPFs), low-pass filters (LPFs) or other types of filters, to generate RF signals 1215 for subsequent transmission (e.g., by one or more of the antennas 1101 (FIG. 11)) via an example duplexer 1214.

In some dual-mode embodiments for Wi-Fi communication, the FEM circuitry 1104a may be configured to operate in either the 2.4 GHz frequency spectrum or the 5 GHz frequency spectrum. In these embodiments, the receive signal path of the FEM circuitry 1104a may include a receive signal path duplexer 1204 to separate the signals from each spectrum as well as provide a separate LNA 1206 for each spectrum as shown. In these embodiments, the transmit signal path of the FEM circuitry 1104a may also include a power amplifier 1210 and a filter 1212, such as a BPF, an LPF or another type of filter for each frequency spectrum and a transmit signal path duplexer 1204 to provide the signals of one of the different spectrums onto a single transmit path for subsequent transmission by the one or more of the antennas 1101 (FIG. 11). In some embodiments, BT communications may utilize the 2.4 GHz signal paths and may utilize the same FEM circuitry 1104a as the one used for WLAN communications.

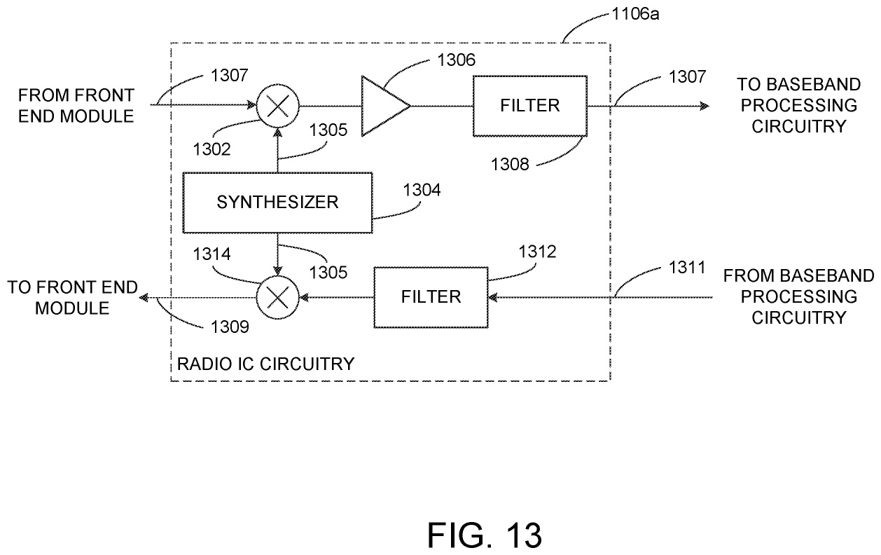

FIG. 13 illustrates radio IC circuitry 1106a in accordance with some embodiments. The radio IC circuitry 1106a is one example of circuitry that may be suitable for use as the WLAN or BT radio IC circuitry 1106a/1106b (FIG. 11), although other circuitry configurations may also be suitable. Alternatively, the example of FIG. 13 may be described in conjunction with the example BT radio IC circuitry 1106b.

In some embodiments, the radio IC circuitry 1106a may include a receive signal path and a transmit signal path. The receive signal path of the radio IC circuitry 1106a may include at least mixer circuitry 1302, such as, for example, down-conversion mixer circuitry, amplifier circuitry 1306 and filter circuitry 1308. The transmit signal path of the radio IC circuitry 1106a may include at least filter circuitry 1312 and mixer circuitry 1314, such as, for example, up-conversion mixer circuitry. Radio IC circuitry 1106a may also include synthesizer circuitry 1304 for synthesizing a frequency 1305 for use by the mixer circuitry 1302 and the mixer circuitry 1314. The mixer circuitry 1302 and/or 1314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 13 illustrates only a simplified version of a radio IC circuitry, and may include, although not shown, embodiments where each of the depicted circuitries may include more than one component. For instance, mixer circuitry 1314 may each include one or more mixers, and filter circuitries 1308 and/or 1312 may each include one or more filters, such as one or more BPFs and/or LPFs according to application needs. For example, when mixer circuitries are of the direct-conversion type, they may each include two or more mixers.

In some embodiments, mixer circuitry 1302 may be configured to down-convert RF signals 1207 received from the FEM circuitry 1104a-b (FIG. 11) based on the synthesized frequency 1305 provided by synthesizer circuitry 1304. The amplifier circuitry 1306 may be configured to amplify the down-converted signals and the filter circuitry 1308 may include an LPF configured to remove unwanted signals from the down-converted signals to generate output baseband signals 1307. Output baseband signals 1307 may be provided to the baseband processing circuitry 1108a-b (FIG. 11) for further processing. In some embodiments, the output baseband signals 1307 may be zero-frequency baseband signals, although this is not a requirement. In some embodiments, mixer circuitry 1302 may comprise passive mixers, although the scope of the embodiments is not limited in this respect.

In some embodiments, the mixer circuitry 1314 may be configured to up-convert input baseband signals 1311 based on the synthesized frequency 1305 provided by the synthesizer circuitry 1304 to generate RF output signals 1209 for the FEM circuitry 1104a-b. The baseband signals 1311 may be provided by the baseband processing circuitry 1108a-b and may be filtered by filter circuitry 1312. The filter circuitry 1312 may include an LPF or a BPF, although the scope of the embodiments is not limited in this respect.

In some embodiments, the mixer circuitry 1302 and the mixer circuitry 1314 may each include two or more mixers and may be arranged for quadrature down-conversion and/or up-conversion respectively with the help of synthesizer 1304. In some embodiments, the mixer circuitry 1302 and the mixer circuitry 1314 may each include two or more mixers each configured for image rejection (e.g., Hartley image rejection). In some embodiments, the mixer circuitry 1302 and the mixer circuitry 1314 may be arranged for direct down-conversion and/or direct up-conversion, respectively. In some embodiments, the mixer circuitry 1302 and the mixer circuitry 1314 may be configured for super-heterodyne operation, although this is not a requirement.

Mixer circuitry 1302 may comprise, according to one embodiment: quadrature passive mixers (e.g., for the in-phase (I) and quadrature phase (Q) paths). In such an embodiment, RF input signal 1207 from FIG. 13 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1305 of synthesizer 1304 (FIG. 13). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1207 (FIG. 12) may comprise a balanced signal, although the scope of the embodiments is not limited in this respect. The I and Q baseband output signals may be provided to low-noise amplifier, such as amplifier circuitry 1306 (FIG. 13) or to filter circuitry 1308 (FIG. 13).

In some embodiments, the output baseband signals 1307 and the input baseband signals 1311 may be analog baseband signals, although the scope of the embodiments is not limited in this respect. In some alternate embodiments, the output baseband signals 1307 and the input baseband signals 1311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1304 may be a fractional-N synthesizer or a fractional N/N+1 synthesizer, although the scope of the embodiments is not limited in this respect as other types of frequency synthesizers may be suitable. For example, synthesizer circuitry 1304 may be a delta-sigma synthesizer, a frequency multiplier, or a synthesizer comprising a phase-locked loop with a frequency divider. According to some embodiments, the synthesizer circuitry 1304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1304 may be provided by a voltage controlled oscillator (VCO), although that is not a requirement. A divider control input may further be provided by either the baseband processing circuitry 1108a-b (FIG. 11) depending on the desired output frequency 1305. In some embodiments, a divider control input (e.g., N) may be determined from a look-up table (e.g., within a Wi-Fi card) based on a channel number and a channel center frequency as determined or indicated by the example application processor 1110. The application processor 1110 may include, or otherwise be connected to, one of the example secure signal converter 101 or the example received signal converter 103 (e.g., depending on which device the example radio architecture is implemented in).

In some embodiments, synthesizer circuitry 1304 may be configured to generate a carrier frequency as the output frequency 1305, while in other embodiments, the output frequency 1305 may be a fraction of the carrier frequency (e.g., one-half the carrier frequency, one-third the carrier frequency). In some embodiments, the output frequency 1305 may be a LO frequency (fLO).

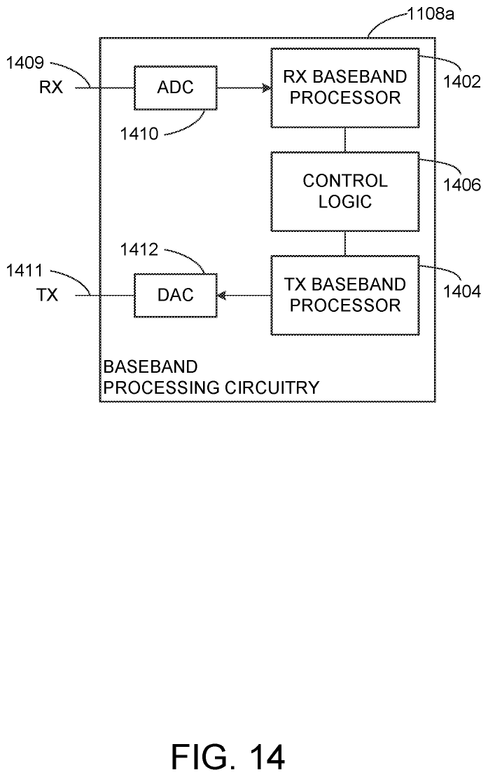

FIG. 14 illustrates a functional block diagram of baseband processing circuitry 1108a in accordance with some embodiments. The baseband processing circuitry 1108a is one example of circuitry that may be suitable for use as the baseband processing circuitry 1108a (FIG. 11), although other circuitry configurations may also be suitable. Alternatively, the example of FIG. 13 may be used to implement the example BT baseband processing circuitry 1108b of FIG. 11.

The baseband processing circuitry 1108a may include a receive baseband processor (RX BBP) 1402 for processing receive baseband signals 1309 provided by the radio IC circuitry 1106a-b (FIG. 11) and a transmit baseband processor (TX BBP) 1404 for generating transmit baseband signals 1311 for the radio IC circuitry 1106a-b. The baseband processing circuitry 1108a may also include control logic 1406 for coordinating the operations of the baseband processing circuitry 1108a.

In some embodiments (e.g., when analog baseband signals are exchanged between the baseband processing circuitry 1108a-b and the radio IC circuitry 1106a-b), the baseband processing circuitry 1108a may include ADC 1410 to convert analog baseband signals 1409 received from the radio IC circuitry 1106a-b to digital baseband signals for processing by the RX BBP 1402. In these embodiments, the baseband processing circuitry 1108a may also include DAC 1412 to convert digital baseband signals from the TX BBP 1404 to analog baseband signals 1411.

In some embodiments that communicate OFDM signals or OFDMA signals, such as through baseband processor 1108a, the transmit baseband processor 1404 may be configured to generate OFDM or OFDMA signals as appropriate for transmission by performing an inverse fast Fourier transform (IFFT). The receive baseband processor 1402 may be configured to process received OFDM signals or OFDMA signals by performing an FFT. In some embodiments, the receive baseband processor 1402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 11, in some embodiments, the antennas 1101 (FIG. 11) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1101 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: generate a frame for 60 gigahertz (GHz) transmission, the frame comprising one or more fields to carry information associated with one or more station devices (STAs); generate a modified legacy signal (L-SIG) field comprising one or more subfields for operation in the 60 GHz transmission; generate a modified legacy long training field (L-LTF) for operation in the 60 GHz transmission; utilize 56 subcarriers in the modified L-LTF in the frame; and cause to send the frame comprising the modified L-LTF and the modified L-SIG to the one or more STAs.

Example 2 may include the device of example 1 and/or some other example herein, wherein the modified L-SIG field comprise 24 bits divided between the one or more subfields.

Example 3 may include the device of example 2 and/or some other example herein, wherein the one or more subfields comprise an early signaling subfield, a transmission time subfield, a parity field subfield, and a signal tail subfield.

Example 4 may include the device of example 3 and/or some other example herein, wherein the early signaling subfield comprises an 802.11 standard version, a bandwidth field, or a variable field associated with early signaling.

Example 5 may include the device of example 1 and/or some other example herein, wherein the modified L-SIG comprises 52 data subcarriers and 4 pilot subcarriers.

Example 6 may include the device of example 1 and/or some other example herein, wherein additional 4 subcarriers in the modified L-LTF are assigned values of [−1, −1, −1, 1] corresponding to subcarriers [−28, −27, 27, 28] respectively.

Example 7 may include the device of example 1 and/or some other example herein, wherein the transmission time subfield may be a period of time indicates that a legacy device to divert from decoding the frame.

Example 8 may include the device of example 1 and/or some other example herein, wherein the parity field subfield may be at least 4 bits long.

Example 9 may include the device of example 1 and/or some other example herein, wherein the modified L-SIG field may be repeated in an adjacent field.

Example 10 may include the device of example 1 and/or some other example herein, wherein the modified L-LTF and the modified L-SIG are repeated in adjacent fields.

Example 11 may include the device of example 1 and/or some other example herein, wherein the legacy short training field (L-STF), modified L-LTF and modified L-SIG are repeated in adjacent fields.

Example 12 may include a non-transitory computer-readable medium storing computer-executable instructions which when executed by one or more processors result in performing operations comprising: generating a frame for 60 gigahertz (GHz) transmission, the frame comprising one or more fields to carry information associated with one or more station devices (STAs); generating a modified legacy signal (L-SIG) field comprising one or more subfields for operation in the 60 GHz transmission; generating a modified legacy long training field (L-LTF) for operation in the 60 GHz transmission; utilizing 56 subcarriers in the modified L-LTF in the frame; and causing to send the frame comprising the modified L-LTF and the modified L-SIG to the one or more STAs.

Example 13 may include the non-transitory computer-readable medium of example 12 and/or some other example herein, wherein the modified L-SIG field comprise 24 bits divided between the one or more subfields.

Example 14 may include the non-transitory computer-readable medium of example 13 and/or some other example herein, wherein the one or more subfields comprise an early signaling subfield, a transmission time subfield, a parity field subfield, and a signal tail subfield. Example 15 may include the non-transitory computer-readable medium of example 14 and/or some other example herein, wherein the early signaling subfield comprises an 802.11 standard version, a bandwidth field, or a variable field associated with early signaling.

Example 16 may include the non-transitory computer-readable medium of example 12 and/or some other example herein, wherein the modified L-SIG comprises 52 data subcarriers and 4 pilot subcarriers.

Example 17 may include the non-transitory computer-readable medium of example 12 and/or some other example herein, wherein additional 4 subcarriers in the modified L-LTF are assigned values of [−1, −1, −1, 1] corresponding to subcarriers [−28, −27, 27, 28] respectively.

Example 18 may include the non-transitory computer-readable medium of example 12 and/or some other example herein, wherein the transmission time subfield may be a period of time indicates that a legacy device to divert from decoding the frame.

Example 19 may include a method comprising: generating, by one or more processors, a frame for 60 gigahertz (GHz) transmission, the frame comprising one or more fields to carry information associated with one or more station devices (STAs); generating a modified legacy signal (L-SIG) field comprising one or more subfields for operation in the 60 GHz transmission; generating a modified legacy long training field (L-LTF) for operation in the 60 GHz transmission; utilizing 56 subcarriers in the modified L-LTF in the frame; and causing to send the frame comprising the modified L-LTF and the modified L-SIG to the one or more STAs.

Example 20 may include the method of example 19 and/or some other example herein, wherein the modified L-SIG field comprise 24 bits divided between the one or more subfields.

Example 21 may include the method of example 20 and/or some other example herein, wherein the one or more subfields comprise an early signaling subfield, a transmission time subfield, a parity field subfield, and a signal tail subfield.

Example 22 may include the method of example 21 and/or some other example herein, wherein the early signaling subfield comprises an 802.11 standard version, a bandwidth field, or a variable field associated with early signaling.

Example 23 may include the method of example 19 and/or some other example herein, wherein the modified L-SIG comprises 52 data subcarriers and 4 pilot subcarriers.

Example 24 may include the method of example 19 and/or some other example herein, wherein additional 4 subcarriers in the modified L-LTF are assigned values of [−1, −1, −1, 1] corresponding to subcarriers [−28, −27, 27, 28] respectively.

Example 25 may include the method of example 19 and/or some other example herein, wherein the transmission time subfield may be a period of time indicates that a legacy device to divert from decoding the frame.

Example 26 may include the method of example 19 and/or some other example herein, wherein the parity field subfield may be at least 4 bits long.

Example 27 may include the method of example 19 and/or some other example herein, wherein the modified L-SIG field may be repeated in an adjacent field.

Example 28 may include the method of example 19 and/or some other example herein, wherein the modified L-LTF and the modified L-SIG are repeated in adjacent fields.

Example 29 may include the method of example 19 and/or some other example herein, wherein the legacy short training field (L-STF), modified L-LTF and modified L-SIG are repeated in adjacent fields.

Example 30 may include an apparatus comprising means for: generating a frame for 60 gigahertz (GHz) transmission, the frame comprising one or more fields to carry information associated with one or more station devices (STAs); generating a modified legacy signal (L-SIG) field comprising one or more subfields for operation in the 60 GHz transmission; generating a modified legacy long training field (L-LTF) for operation in the 60 GHz transmission; utilizing 56 subcarriers in the modified L-LTF in the frame; and causing to send the frame comprising the modified L-LTF and the modified L-SIG to the one or more STAs.

Example 31 may include the apparatus of example 29 and/or some other example herein, wherein the modified L-SIG field comprise 24 bits divided between the one or more subfields.

Example 32 may include the apparatus of example 30 and/or some other example herein, wherein the one or more subfields comprise an early signaling subfield, a transmission time subfield, a parity field subfield, and a signal tail subfield.

Example 33 may include the apparatus of example 31 and/or some other example herein, wherein the early signaling subfield comprises an 802.11 standard version, a bandwidth field, or a variable field associated with early signaling.

Example 34 may include the apparatus of example 29 and/or some other example herein, wherein the modified L-SIG comprises 52 data subcarriers and 4 pilot subcarriers. Example 35 may include the apparatus of example 29 and/or some other example herein, wherein additional 4 subcarriers in the modified L-LTF are assigned values of [−1, −1, −1, 1] corresponding to subcarriers [−28, −27, 27, 28] respectively.

Example 36 may include the apparatus of example 29 and/or some other example herein, wherein the transmission time subfield may be a period of time indicates that a legacy device to divert from decoding the frame.

Example 37 may include the apparatus of example 29 and/or some other example herein, wherein the parity field subfield may be at least 4 bits long.

Example 38 may include the apparatus of example 29 and/or some other example herein, wherein the modified L-SIG field may be repeated in an adjacent field.

Example 39 may include the apparatus of example 29 and/or some other example herein, wherein the modified L-LTF and the modified L-SIG are repeated in adjacent fields.

Example 40 may include the apparatus of example 29 and/or some other example herein, wherein the legacy short training field (L-STF), modified L-LTF and modified L-SIG are repeated in adjacent fields.

Example 41 may include one or more non-transitory computer-readable media comprising instructions to cause an electronic device, upon execution of the instructions by one or more processors of the electronic device, to perform one or more elements of a method described in or related to any of examples 1-40, or any other method or process described herein.

Example 42 may include an apparatus comprising logic, modules, and/or circuitry to perform one or more elements of a method described in or related to any of examples 1-40, or any other method or process described herein.

Example 43 may include a method, technique, or process as described in or related to any of examples 1-40, or portions or parts thereof.

Example 44 may include an apparatus comprising: one or more processors and one or more computer readable media comprising instructions that, when executed by the one or more processors, cause the one or more processors to perform the method, techniques, or process as described in or related to any of examples 1-40, or portions thereof.

Example 45 may include a method of communicating in a wireless network as shown and described herein.

Example 46 may include a system for providing wireless communication as shown and described herein.

Example 47 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
generate a frame for 60 gigahertz (GHz) transmission, the frame comprising one or more fields to carry information associated with one or more station devices (STAs);
generate a modified legacy signal (L-SIG) field comprising one or more subfields for operation in the 60 GHz transmission;
generate a modified legacy long training field (L-LTF) for operation in the 60 GHz transmission;
utilize 56 subcarriers in the modified L-LTF in the frame; and
cause to send the frame comprising the modified L-LTF and the modified L-SIG to the one or more STAs.

2. The device of claim 1, wherein the modified L-SIG field comprise 24 bits divided between the one or more subfields.

3. The device of claim 2, wherein the one or more subfields comprise an early signaling subfield, a transmission time subfield, a parity field subfield, and a signal tail subfield.

4. The device of claim 3, wherein the early signaling subfield comprises an 802.11 standard version, a bandwidth field, or a variable field associated with early signaling.

5. The device of claim 1, wherein the modified L-SIG comprises 52 data subcarriers and 4 pilot subcarriers.

6. The device of claim 1, wherein additional 4 subcarriers in the modified L-LTF are assigned values of [−1, −1, −1, 1] corresponding to subcarriers [−28, −27, 27, 28] respectively.

7. The device of claim 1, wherein the transmission time subfield is a period of time indicates that a legacy device to divert from decoding the frame.

8. The device of claim 1, wherein the parity field subfield is at least 4 bits long.

9. The device of claim 1, wherein the modified L-SIG field is repeated in an adjacent field.

10. The device of claim 1, wherein the modified L-LTF and the modified L-SIG are repeated in adjacent fields.

11. The device of claim 1, wherein the legacy short training field (L-STF), modified L-LTF and modified L-SIG are repeated in adjacent fields.

12. A non-transitory computer-readable medium storing computer-executable instructions which when executed by one or more processors result in performing operations comprising:
generating a frame for 60 gigahertz (GHz) transmission, the frame comprising one or more fields to carry information associated with one or more station devices (STAs);
generating a modified legacy signal (L-SIG) field comprising one or more subfields for operation in the 60 GHz transmission;
generating a modified legacy long training field (L-LTF) for operation in the 60 GHz transmission;
utilizing 56 subcarriers in the modified L-LTF in the frame; and
causing to send the frame comprising the modified L-LTF and the modified L-SIG to the one or more STAs.

13. The non-transitory computer-readable medium of claim 12, wherein the modified L-SIG field comprise 24 bits divided between the one or more subfields.

14. The non-transitory computer-readable medium of claim 13, wherein the one or more subfields comprise an early signaling subfield, a transmission time subfield, a parity field subfield, and a signal tail subfield.

15. The non-transitory computer-readable medium of claim 14, wherein the early signaling subfield comprises an 802.11 standard version, a bandwidth field, or a variable field associated with early signaling.

16. The non-transitory computer-readable medium of claim 12, wherein the modified L-SIG comprises 52 data subcarriers and 4 pilot subcarriers.

17. The non-transitory computer-readable medium of claim 12, wherein additional 4 subcarriers in the modified L-LTF are assigned values of [−1, −1, −1, 1] corresponding to subcarriers [−28, −27, 27, 28] respectively.

18. The non-transitory computer-readable medium of claim 12, wherein the transmission time subfield is a period of time indicates that a legacy device to divert from decoding the frame.

19. A method comprising:
generating, by one or more processors, a frame for 60 gigahertz (GHz) transmission, the frame comprising one or more fields to carry information associated with one or more station devices (STAs);
generating a modified legacy signal (L-SIG) field comprising one or more subfields for operation in the 60 GHz transmission;
generating a modified legacy long training field (L-LTF) for operation in the 60 GHz transmission;
utilizing 56 subcarriers in the modified L-LTF in the frame; and
causing to send the frame comprising the modified L-LTF and the modified L-SIG to the one or more STAs.

20. The method of claim 19, wherein the modified L-SIG field comprise 24 bits divided between the one or more subfields.
